(19) United States
(12) Patent Application Publication
(10) Pub. No.: US 2021/0122113 A1
(43) Pub. Date: Apr. 29, 2021

(54) LASER FORMING DEVICE

(71) Applicant: INSSTEK INC., Daejeon (KR)

(72) Inventors: Suk Hyun SEO, Daejeon (KR); Seung Hwan LIM, Daejeon (KR)

(73) Assignee: INSSTEK INC., Daejeon (KR)

(21) Appl. No.: 17/082,584

(22) Filed: Oct. 28, 2020

(30) Foreign Application Priority Data
Oct. 28, 2019 (KR) 10-2019-0134914

(51) Int. Cl. B29C 64/268; B29C 64/205; B29C 64/241; B29C 64/255; B29C 64/153

(52) U.S. Cl. CPC B29C 64/268; B29C 64/205; B33Y 10/00; B29C 64/255; B29C 64/153; B29C 64/241

(57) ABSTRACT

A laser forming device includes a powder discharger configured to discharge powder to a molding object, a laser irradiator configured to irradiate the discharged powder with energy, and a powder supplier configured to the powder to the powder discharger. The powder discharger includes a first divider configured to surround a side surface of the laser irradiator so that the powder is introduced into the first divider and is discharged in at least two directions, and a division selector configured to rotate the first divider with the laser irradiator as an axis.

### CROSS-REFERENCE TO PRIOR APPLICATION

This application claims priority to Korean Patent Application No. 10-2019-0134914 (filed on Oct. 28, 2019), which is hereby incorporated by reference in its entirety.

### BACKGROUND

A technology disclosed in the present disclosure relates to a laser forming device, and more particularly, to a laser molding device capable of performing stable laser forming by discharging even powder at a forming point which is irradiated with laser.

The technology disclosed in the present disclosure relates to a laser molding apparatus, and typically includes laser-aided direct metal manufacturing. In a laser direct metal deposition technology, it is possible to manufacture a three-dimensional product or a tool required for producing a product in a very short time using a laser cladding technology which uses a functional material (metal, alloy, ceramic, or the like) and precisely welds the material directly with a laser according to digital data of 3D subjects stored in a computer. 3D shape information includes 3D CAD data, medical Computer Tomography (CT), and Magnetic Resonance Imaging (MRI) data, digital data measured by a 3D scanner (3D Object Digitizing System, or the like. The tool refers to a mass-produced mold required for producing a product such as a die and a mold. According to this technology, it is possible to manufacture a metal prototype, a mass-produced mold, a final product having a complex shape, and various tools in a short time incomparable to a conventional machining method such as cutting and casting using a Computerized Numerical Control (CNC) and other machining machines, and this technology can be also applied to restoration, remodeling, and repairing of a mold using reverse engineering. A basic concept of realizing a physical shape from CAD data is similar to that of a general printer. Just as a printer creates a document by coating ink at an exact position on a two-dimensional paper plane using a document data file stored in a computer, the direct metal deposition technology implements a three-dimensional physical shape by forming a required amount of the functional material at an exact position in a three-dimensional space using three-dimensional CAD data. This technology is being developed as a three-dimensional printer, and recently, is commercialized in different directions depending on the characteristics of materials such as plastic, ceramic, paper, and metal. In the laser direct metal shaping technology, the two-dimensional plane is physically realized using laser cladding technology.

In the conventional Korean Laid-Open Patent Publication No. 10-2017-0097420 (published on Aug. 28, 2017, “amorphous metal manufacturing device using a three-dimensional metal printer and amorphous metal manufactured therein”), a laser irradiator which irradiates a specimen with a laser beam to generate a molten pool, a powder supplier which supplies metal powder to the generated molten pool, a controller which controls a movement of the laser irradiation unit according to a thickness and 3D CAD data of a metal molten solution in which the metal powder is melted, and a cooler which rapidly cools the metal molten solution by the amorphous metal are provided. The amorphous metal manufacturing device using the 3D metal printer may further include a photographer which photographs an image of the metal molten solution and an image analyzer which analyzes the photographed image to measure a thickness of the metal molten solution. The controller calculates a tool path from the 3D CAD data, and when the thickness of the metal molten solution reaches a preset thickness, the controller may move the laser irradiator along the calculated tool path. The cooler may use an inert gas to rapidly cool the molten metal melt along the tool path with the amorphous metal to the preset thickness. The metal powder may include at least one of Ni, Ce, La, Gd, Mg, Y, Sm, Zr, Fe, Ti, Co, Al, Cu, Mo, Sn, Nb, and Si. The amorphous metal manufacturing device using the 3D metal printer may further include a laser oscillator which oscillates the laser beam and a laser concentrator which condenses the oscillated laser beam. The laser irradiator may irradiate the specimen with the focused laser beam. The controller may control the movement of the laser irradiator to maintain a focal length of the laser beam while the laser irradiator performs irradiation of the laser beam. The controller may control a spraying speed of the metal powder supplied from the powder supplier in response to a moving speed of the laser irradiator. This invention discloses a technology capable of manufacturing the amorphous metal by the amorphous metal manufacturing device using the three-dimensional metal printer.

In the conventional Korean Laid-Open Patent Publication No. 10-1058382 (published on Aug. 22, 2011, a “nozzle for laser metal coating device”), a technology is disclosed, which includes a body in which a laser beam exit hole through which a laser beam is emitted is formed at a center, a powder supply line which is connected to one side of the body and mixes and supplies a carrier gas and metal powder, a purging gas supply line which is connected at a position which does not interfere with the powder supply line and supplies a purging gas, a powder flow passage which is formed in the body to be connected to the powder supply line and forms a conduit which receives the carrier gas and the metal powder to eject to one side of the laser beam exit hole, first and second cooling channels which are connected to the purging gas supply line to receive the purging gas, ejects the purging gas through the laser beam exit hole, is configured to surround an outer surface of one side of the body, and to which cooling water is supplied from the outside, and a third nozzle which receives air from the outside through a conical member into which a first nozzle is inserted with a gap, introduces the air between the first nozzle and the third nozzle to form an air curtain hall around the ejected powder.

In the conventional Korean Laid-Open Patent Publication No. 10-2018-0040531 (published on Apr. 20, 2018, a “3D printing laser beam irradiation device and a 3D printing laser beam irradiation system including the same”), a technology is disclosed, which includes a laser beam aligner which causes a path of a diverged laser beam to be a parallel path and variably adjusts a width of the parallel path and a laser beam condenser which condenses the laser beam incident through the laser beam aligner and irradiates the 3D stacked portion with the laser beam, and changes a size of the laser beam with which the 3D stacked portion is irradiated through the laser beam condenser according to the width adjustment of the laser beam by the laser beam aligner. The laser beam aligner may include a first collimation lens which causes the path of the incident laser beam to be parallel. The laser beam aligner may further include a converging lens for converging the laser beam which has passed through the first collimation lens. Moreover, a technology of movably mounting the converging lens is disclosed.

### SUMMARY

A technology disclosed in the present disclosure provides a laser forming device capable of more stably performing laser forming.

According to an embodiment, there is provided a laser forming device.

The laser forming device may include: a powder discharger 100 configured to discharge powder 10 to a molding object 1; a laser irradiator 200 configured to irradiate the discharged powder 10 with energy; and a powder supplier configured to the powder 10 to the powder discharger 100, in which the powder discharger 100 may include a first divider 110 configured to surround a side surface of the laser irradiator 200 so that the powder 100 is introduced into the first divider and is discharged in at least two directions, and a division selector 120 configured to rotate the first divider 110 with the laser irradiator 200 as an axis.

The first divider 110 may include a ring-shaped first division body 111 configured to include a first space a which stores the powder 10, a first division inlet 112 configured to be provided in an upper portion of the first division body 111 so that the powder 10 is introduced into the first division inlet 112, a first division discharge 113 configured to be provided so that the introduced powder 10 falls to a lower portion of the first division body 111 and provided in each of at least two positions, and a first division wall 114 configured to divide the first space a between the first division discharges 113.

The powder discharger 100 may further include a second divider 130, the division selector 120 may rotate at least one of the first divider 110 and the second divider 120, and the second divider 130 may include a ring-shaped second division body 131 configured to include a second space b which stores the powder 10, a second division inlet 132 configured to be provided in an upper portion of the second division body 131 so that the powder 10 which has fallen from the first divider 130 is introduced into the second division inlet 132, a second division discharge 133 configured to be provided so that the introduced powder 10 falls to a lower portion of the second division body 131 and provided at positions more than those of the first division discharge 113, and a second division wall 134 configured to divide the second space b between the second division discharges 133.

The laser forming device disclosed in the present disclosure divides and discharges a predetermined amount of powder 10 supplied from the powder supplier 300 through the powder discharge 100 about a forming position toward which the laser irradiator 200 is directed. The divided and discharged powder 10 has an effect of increasing accuracy of laser forming by forming the powder 10 having an even upper surface at the forming position to which the laser irradiator 200 is directed.

In the laser forming device disclosed in the present disclosure, a predetermined amount of powder 10 supplied from the powder supplier 300 is further divided and discharged about the forming position toward which the laser irradiator 200 is directed, by the first divider 110 and the second divider 130. The divided and discharged powder 10 has an effect of further increasing the accuracy of the laser forming by forming the powder 10 having a more even upper surface at the molding position toward which the laser irradiator 200 is directed.

It is possible to easily adjust a height of the powder 10 accumulated on the molding object 1 without adjusting the amount of powder 10 used for the forming by selecting a direction or position at which the powder 10 is discharged through a control of the division selector 120.

The above description provides only an optional concept in a simplified form for matters to be described in more detail later. The present disclosure is not intended to limit main features or essential features of claims or to limit a scope of claims.

### BRIEF DESCRIPTION OF THE DRAWINGS

FIG. 1 is a view schematically illustrating the entire laser forming device according to the present disclosure.

FIG. 2 is an exploded view of a powder discharge according to the present disclosure.

FIG. 3 is a cross-sectional view of a first divider and a division selector of the powder discharger illustrated in FIG. 2.

FIG. 4 is a second divider of the powder discharger illustrated in FIG. 2.

FIG. 5 is a view illustrating a state where powder discharged from a powder discharger according to an embodiment is accumulated.

FIG. 6 is a view illustrating a state where powder discharged from a powder discharger according to another embodiment is accumulated.

### DETAILED DESCRIPTION

Hereinafter, embodiments disclosed in the present disclosure will be described in detail with reference to the drawings. Unless otherwise specified in the present specification, similar reference numbers in the drawings indicate similar components. Exemplary embodiments described in the detailed description, drawings, and claims are not intended to be limiting, and other embodiments may be used, and other changes may be made without departing from a spirit or scope of a technology disclosed herein. A person skilled in the art will be easy to understand that components of the present disclosure, that is, components generally described herein and described in the drawings may be arranged, configured, combined, and designed in various different configurations, all of which are clearly devised and form a part of the present disclosure. In the drawings, in order to clearly express various layers (or films), regions, and shapes, a width, length, thickness, or shape of a component may be exaggerated.

When one component is referred to as “disposition” to another component, it may include a case where an additional component is interposed between them, as well as a case where the one component is directly disposed on the other component.

When one component is referred to as “connection” to another component, it may include a case where an additional component is interposed therebetween, as well as a case where the one component is directly connected to the other component.

When one component is referred to as “formation” to another component, it may include a case where an additional component is interposed therebetween, as well as a case where the one component is directly formed on the other component.

When one component is referred to as “coupling” to another component, it may include a case where an additional component is interposed therebetween, as well as a case where the one component is directly coupled to the other component.

Since description of a disclosed technology is merely an embodiment for structural or functional description, a scope of rights of the disclosed technology should not be construed as being limited by the embodiments described in the present specification. That is, since the embodiments can be variously changed and have various forms, the scope of rights of the disclosed technology should be understood as including equivalents capable of realizing the technical idea.

Expressions in the singular are to be understood as including the plural expressions, unless the context clearly indicates otherwise, and it is to be understood that terms such as “include” or “have” are intended to designate the presence of implement feature, number, step, action, component, part, or combination thereof, and do not preclude possibility of the presence or addition of one or more other features, numbers, steps, actions, components, parts, or combinations thereof.

All terms used herein have the same meaning as commonly understood by one of ordinary skill in the field to which the disclosed technology belongs, unless otherwise defined. As defined in a commonly used dictionary, terms should be construed as being consistent with the meaning of the related technology, and cannot be construed as having an ideal or excessive formal meaning unless explicitly defined in the present application.

Hereinafter, a laser forming device disclosed in the present disclosure will be roughly described with reference to the drawings. The laser forming device disclosed in the present disclosure with reference to the drawings may largely include a powder supplier 100, a laser irradiator 200 and a powder discharger 300.

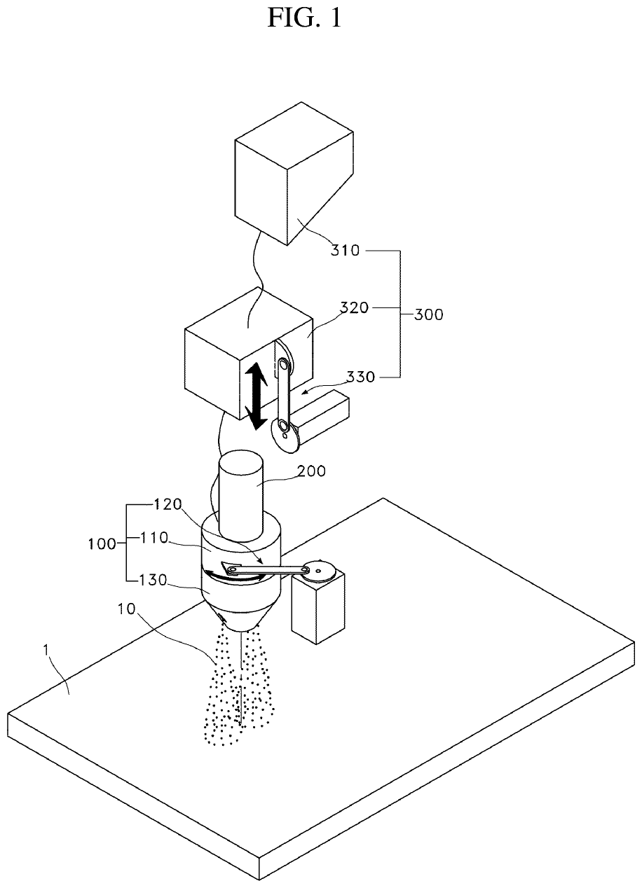

The laser forming device according to the embodiment with reference to FIG. 1 includes the powder discharger 100 which discharges powder 10 to a molding object 1, the laser irradiator 200 which irradiates the discharged powder 10 with energy, and the powder supplier 300 which supplies the powder 10 to the powder discharger 100.

The powder discharger 100 is provided to discharge the powder 10 to the molding object 1. The molding object 1 may be provided as an article to which laser forming is added or as a support for supporting the laser forming article.

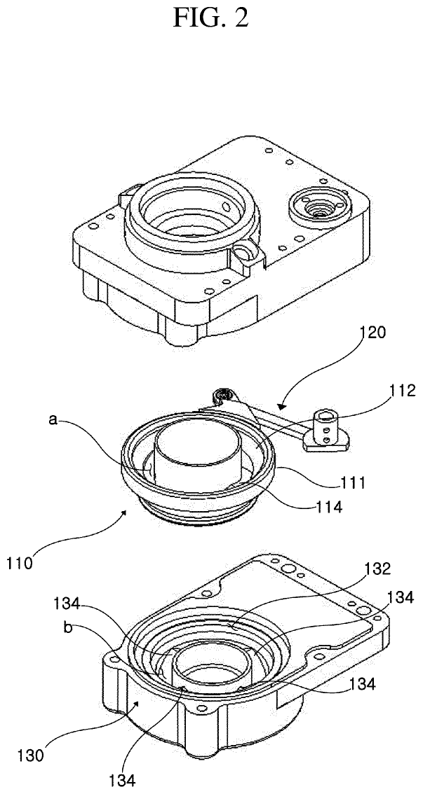

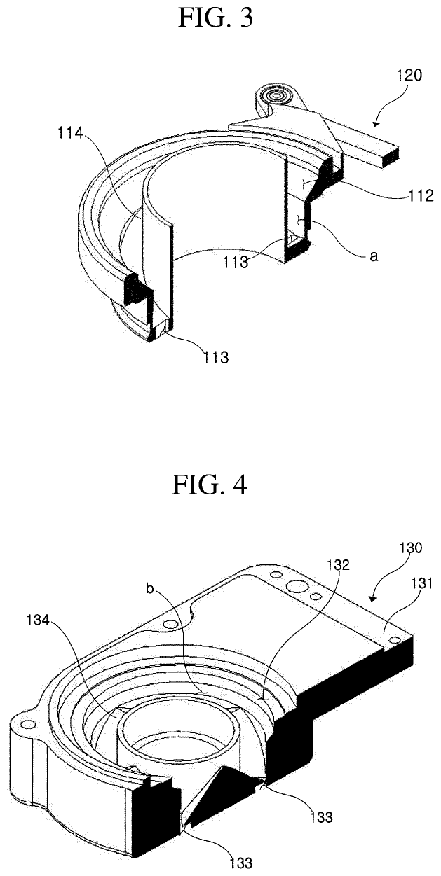

As an example with reference to FIGS. 2 and 3, the powder discharger 100 may include a first divider which is provided to surround a side surface of the laser irradiator 200 and allows the powder 10 to be introduced and discharged in at least two directions. The powder discharger 100 may include a division selector 120 which rotates the first divider 110 with the laser irradiator 200 as an axis.

In more detail, the first divider 110 may largely include a first division body 111, a first division inlet 112, a first division discharge 113, and a first division wall 114. The first division body 111 may be provided in a ring shape including a first space a in which the powder 10 can be stored. The first division body 111 may be viewed as a ring-shaped cup. The first division inlet 112 may be provided in an upper portion of the first division body 111 and provided as an open space into which the powder 10 is introduced. The first division discharge 113 is provided to form a hole in a lower portion of the first division body 111 so that the powder 10 introduced from the powder supplier 300 falls, and the first division discharge 113 may be provided in each of at least two different positions. The first division discharge 113 may be provided at positions facing each other. The first division wall 114 may include the first division wall 114 which bisects the first space a between the first division discharges 113. The first division wall 114 may be provided in a form in which the bottom surface of the first division body 111 protrudes. The first division wall 114 may be provided between two places where the first division discharges 113 are provided. That is, the first division wall 114 divides the first space a of the first division body 111 into two spaces. Meanwhile, the first division wall 114 may be provided so that the bottom surface of the first division body 111 is inclined.

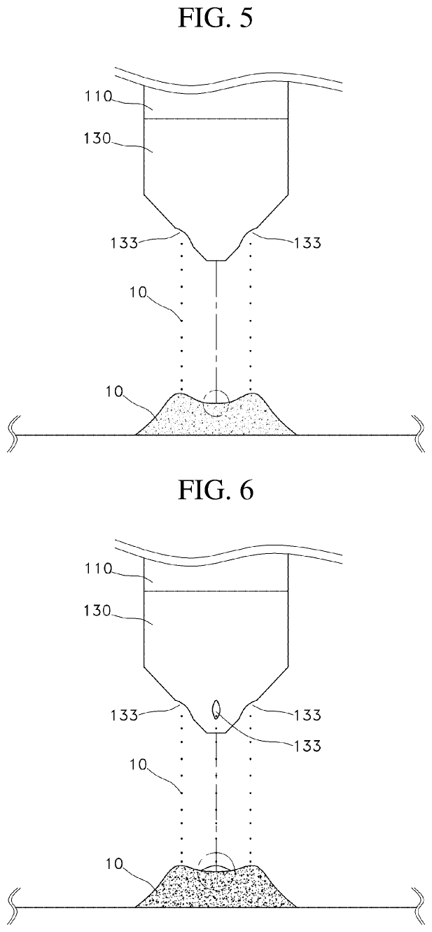

That is, when the powder 10 supplied from the powder supplier 300 is introduced into the first divider 110, the first divider 110 discharges the powder 10 to the lower portion of the first divider 110 toward which the laser irradiator 200 is directed, as illustrated in FIG. 5. Here, the first divider 110 discharges the powder 10 to two positions about the laser irradiator 200 by the first division discharge 113.

As an example with reference to FIG. 2, the division selector 120 may be provided with a general motor (not illustrated) connected to the side surface of the first division body 111 of the first divider 110 by a general crankshaft. The division selector 120 is provided to rotate the first divider 110 with the laser irradiator 200 as an axis and then return the first divider 110 again according to the driving of the motor.

That is, the division selector 120 may selectively change the positions of two spaces divided by the first division wall 114.

Meanwhile, the division selector 120 may selectively change the position of the first division discharge 113.

The powder discharger 100 disclosed in the above example divides and discharges a predetermined amount of powder 10 supplied from the powder supplier 300 about a forming position toward which the laser irradiator 200 is directed. The divided and discharged powder 10 has an effect of increasing the accuracy of laser forming by forming a powder 10 having an even upper surface at the forming position toward which the laser irradiator 200 is directed, as illustrated in FIG. 5.

As another example with reference to FIGS. 2 and 4, the powder discharger 100 may further include a second divider 130 in addition to the above-described first divider 110 and the above-described division selector 120. Meanwhile, the division selector 120 may be provided to rotate the second divider 130.

That is, the division selector 120 may be provided to rotate at least one of the first divider 110 or the second divider 130.

In more detail, the second divider 130 may largely include a second division body 131, a second division inlet 132, a second division discharge 133, and a second division wall 134. The second division body 131 may be provided in a ring shape including a second space b in which the powder 10 is stored. The second division body 131 is provided similarly to the above-described first division body 111. The second division inlet 132 is provided in an upper portion of the second division body 131 and is an open space into which the powder 10 which has fallen from the first divider 130 is introduced. The second division discharge 133 may be provided in a lower portion of the second division body 131 so that the powder 10 introduced into the second space b falls, and provided at positions more than those of the first division discharge 113. The second division discharges 133 may be provided at positions which do not overlap each other. In more detail, the second division discharges 133 may be provided at holes which are formed in four orientations in the lower portion of the second division body 131. The second division wall 134 may be provided to divide the second space b into quarters between the second division discharges 133. The second division wall 134 may be provided in a form in which a bottom surface of the second division body 131 protrudes. The second division walls 134 may be provided between four places where the second division discharges 133 are provided, respectively. That is, the second division wall 134 divides the second space b of the second division body 131 into four spaces. Meanwhile, the second division wall 134 may be provided so that the bottom surface of the second division body 131 is inclined.

That is, the second divider 130 allows the powder 10 introduced from the first divider 110 to be discharged to the lower portion of the second divider 130 toward which the laser irradiator 200 is directed, as illustrated in FIG. 6. Here, the second divider 130 discharges the powder 10 to four positions about the laser irradiator 200 by the second division discharge 133.

In another example, the division selector 120 may evenly introduce the powder 10 into the divided second space b of the fixed second divider 130 by rotating the first divider 110.

Meanwhile, when the division selector 120 is provided to rotate the second divider 130, the discharging position of the divided and discharged powder 10 can be adjusted, and the powder 10 introduced from the first divider 110 can be induced so that the powder 10 is introduced evenly or selectively into the space b. The powder 10 is introduced selectively, and thus, when the powder 10 is discharged in two directions through the first divider 110, if an operation of the division selector (120) stops, the powder 10 can be introduced into the two spaces of the second space b divided into quarters of the second divider 130. That is, the direction or position at which the powder 10 is discharged can be selected through the control of the division selector 120. Furthermore, as the direction or position at which the powder 10 is discharged increases, a height of the powder 10 accumulated in the molding object 1 decreases, and the direction or position at which the powder 10 is discharged decreases, the height of the powder accumulated in the molding object 1 increases. That is, there is an effect that the height of the powder 10 accumulated in the molding object 1 can be easily adjusted without adjusting the amount of the powder 10 used for molding.

The powder discharger 100 disclosed in another example further divides and discharges the predetermined amount of powder 10 supplied from the powder supplier 300 through the first divider 110 and the second divider 130 about the forming position toward which the laser irradiator 200 is directed. The divided and discharged powder 10 has an effect of further increasing the accuracy of laser forming by forming the powder 10 having a more even upper surface at the forming position toward the laser irradiator 200 is directed, as illustrated in FIG. 6.

Further, the powder discharger 100 may further include a third divider (not illustrated) and a fourth divider (not illustrated), and the third divider (not illustrated) added after the second divider 130 is preferable to increase the number of divided powder discharges (not illustrated). As the divider increases, the position at which the powder is discharged increases, and thus, the upper surface of the powder 10 accumulated at the forming position may be in a more even state.

The laser irradiator 200 is provided with a general laser capable of forming metal. The laser irradiator 200 may be inserted and installed in a center of the powder discharger 100. The laser irradiator 200 melts the powder 10 discharged to a surface of the molding object 1 to form a specific shape.

The powder supplier 300 is provided to supply the powder 10 to the powder discharger 100. The powder supplier 300 may largely include a storage 310 in which the powder 10 is stored, a supply controller 320, and a supply driver 330. The storage 310 may be a general box in which the powder 10 is stored. The storage 310 is connected to the supply controller 320 and provided so that the powder 10 is naturally introduced into the supply controller 320. The connection between the storage 310 and the supply controller 320 may be performed by a general hose. The supply controller 320 may be provided so that the stored powder 10 can be introduced and stayed. The supply controller 320 may be provided so that the powder 10 is discharged by an external force. The supply driver 330 may be provided to move the supply controller 320 so that the supply controller 320 repeatedly move upward and downward.

The powder supplier 300 according to the above example forms inertia by moving the supply controller 320 in which the powder 10 stays upward or downward. When the direction of movement of the supply controller 320 from the top to the bottom or from the bottom to the top is reversed by the supply driver 330, the staying powder 10 rapidly moves and is discharged from the supply controller 320.

Meanwhile, the powder supplier 300 may be a general vibration feeder.

From the above, various embodiments of the present disclosure are described for illustration, and it will be understood that there are various possible modifications without departing from the scope and spirit of the present disclosure. Moreover, the disclosed various embodiments are not intended to limit the spirit of the present disclosure, and the true spirit and scope will be presented from the following claims.

What is claimed is:

1. A laser forming device, comprising:
a powder discharger configured to discharge powder to a molding object;
a laser irradiator configured to irradiate the discharged powder with energy; and
a powder supplier configured to the powder to the powder discharger,
wherein the powder discharger includes a first divider configured to surround a side surface of the laser irradiator so that the powder is introduced into the first divider and is discharged in at least two directions, and a division selector configured to rotate the first divider with the laser irradiator as an axis, and
the powder is discharged about a point at which the powder is irradiated with the energy.

2. The laser forming device of claim 1, wherein the first divider includes a ring-shaped first division body configured to include a first space which stores the powder, a first division inlet configured to be provided in an upper portion of the first division body so that the powder is introduced into the first division inlet, a first division discharge configured to be provided so that the introduced powder falls to a lower portion of the first division body and provided in each of at least two positions, and a first division wall configured to divide the first space between the first division discharges.

3. The laser forming device of claim 2, wherein the first division wall causes a bottom surface of the first division body to protrude, and the bottom surface of the first division body is inclined.

4. The laser forming device of claim 2, wherein the powder discharger further includes a second divider,
the division selector rotates at least one of the first divider and the second divider, and
the second divider includes a ring-shaped second division body configured to include a second space which stores the powder, a second division inlet configured to be provided in an upper portion of the second division body so that the powder which has fallen from the first divider is introduced into the second division inlet, a second division discharge configured to be provided so that the introduced powder falls to a lower portion of the second division body and provided at positions more than those of the first division discharge, and a second division wall configured to divide the second space between the second division discharges.

5. The laser forming device of claim 4, wherein the second division wall causes a bottom surface of the second division body to protrude, and the bottom surface of the second division body is inclined.
